(19) United States
(12) Patent Application Publication
(10) Pub. No.: US 2009/0292575 A1
(43) Pub. Date: Nov. 26, 2009

(54) Coalescence of Disparate Quality of Service Matrics Via Programmable Mechanism

(76) Inventors: Edward Ellebracht, Fremont, CA (US); Marek Tlalka, San Marcos, CA (US); Poly Palamuttam, Fremont, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/090,522

(22) PCT Filed: Oct. 18, 2006
(86) PCT No.: PCT/US06/40927

§ 371 Date: Aug. 5, 2008

Related U.S. Application Data
(60) Provisional application No. 60/728,175, filed on Oct. 18, 2005.

(51) Int. Cl. G06Q 10/00; G06Q 50/00

(52) U.S. Cl. 705/8

(57) ABSTRACT

A method for classifying the Quality of Service of the incoming data traffic before the traffic is placed into the priority queues of the Active Queue Management Block of the device is disclosed. By employing a range of mapping schemes during the classification stage of the ingress traffic processing, the invention permits the traffic from a number of users to be coalesced into the appropriate Quality of Service level in the device.

This application claims the benefit of the U.S. Provisional Patent Application No. 60/728,175 filed on Oct. 18, 2005

### BACKGROUND OF THE INVENTION

The invention addresses the need to properly prioritize Ethernet traffic to correspond to the Quality of Service (QoS) a customer has asked for. This occurs prior to the incoming traffic being placed into a queue of the communication device. This invention assures that a customer's data traffic is processed at the level of service the customer subscribed to and provides for a uniform traffic priority marking scheme amongst the network users.

In the area of data transmission the existing technology requires the servicing of the ingress traffic without oversubscription. That is, the Media Access Control (MAC) device is either not permitted to drop traffic or traffic is not properly classified before it is dropped. Both approaches are inferior. In the case where no traffic is allowed to be dropped, a higher capacity (and therefore higher cost) data processing block is used following the MAC. This data processing block is capable of examining all traffic under worst-case conditions. Because today's Ethernet streams typically operate at 10 to 20% of capacity, a much higher performance data processing block is required. If such a block is not employed and the MAC is allowed to indiscriminately drop ingress frames, then inferior, probably unacceptable performance will be provided. This is because some frames should never be dropped, such as control plane frames. Similarly, Voice over Internet Protocol (VoIP) and streaming media frames require special servicing. This servicing is not available if the frames are not classified before the oversubscription block of the system.

The 802.3 Ethernet frame format allows for the user to insert a VLAN tag that provides the Quality of Service (QoS) level for the frame carrying the tag. This is also true of other QoS-marking mechanisms, such as Multi Protocol Label Switching (MPLS) or Differential Service Code Point (DSCP) for Internet Protocol (IP) traffic. However, the definition of these levels may not be coherent between different users. This could allow one use to mark their data as high priority when in fact they should not be given high priority. The reverse is also possible—a user may have paid for a certain Service Level Agreement (SLA) but, because their traffic is not properly marked, they do not receive it. In an oversubscribed device low priority traffic may be dropped before the QoS levels can be properly adjusted using a Network Processing Unit (NPU) or some other Ethernet-aware data processing device.

### SUMMARY OF THE INVENTION

The method described in this invention is capable of employing several different mechanisms for classifying the incoming traffic streams. This ability extends to the data based on vLan tags, layer 2 destination address, Multi Protocol label Switching (MPLS), ethertype, Link Layer Ocntrol (LLC), Layer 3 protocol and/or Differential Service Code Point (DSCP).

### BRIEF DESCRIPTION OF THE DRAWINGS

FIG. 1 is the block diagram of the device

FIG. 1A shows the OSI reference model.

FIG. 2A is the oversubscription block diagram

FIG. 3A is the overall process flow chart.

FIG. 4A is Ethernet frame format with vLAN tag.

FIG. 4B shows the round-robin approach to enqueueing.

FIG. 5A is vLAN priority to queue mapping table.

FIG. 6A shows the WRED drop probability graph.

FIG. 7A is the frame drop behavior table.

FIG. 8 shows the MDRR approach.

### DETAILED DESCRIPTION

In an oversubscription environment, an embodiment of the present invention aggregates large quantity of data and manages an oversubscribed data transmission system. The data enters the device from an 8 port Physical Layer (PHY) by the way of a Reduced Medium Independent Interface (RMII) or Reduced Gigabit Medium Independent Interface (RGMII) through a Media Access Control (MAC) device. Up to three 8 port PHY devices may be used. The incoming data are then classified into high and low priority according to the priority level contained in their virtual Local Area Network (vLAN) tag. The prioritized data are then processed through Weighted Random Early Detection (WRED) routine. The WRED routine prevents congestion before it occurs by dropping some data and passing other according to the pre-determined criteria. The passed data are written into the memory that is divided into 480 1 Kbyte (KB) buffers (blocks). The buffers are further classified into a free list and an allocation list. The data are written into the memory by the Receive Write Memory manager. Each port on the device of this invention accommodates a high priority queue and a low priority queue, with low priority queue being allocated up to 48 blocks and the high priority queue up to 32 blocks. The stored data are read by the Receive Read Memory Manager, with each port being serviced in round robin fashion, and within a port, high and low priority queues are serviced by using Modified Deficit Round Robin (MDRR) approach. The data are then transmitted out of the device via an SPI 4.2 or similar approach.

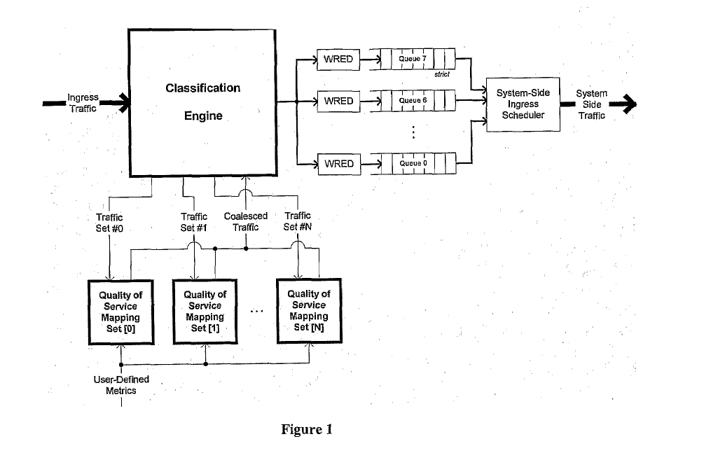

Many different types of hardware and software from a broad base of vendors are continually entering the communications market. In order to enable communications between such devices a set of standards has been developed. Shown in FIG. 1A is an International Standards Organization (ISO) reference model for standardizing communications systems called the Open Systems Interconnect (OSI) Reference Model. The OSI architecture defines the communications process as a set of seven layers, with specific functions isolated and associated with each layer. The layer isolation permits the characteristics of a given layer to change without impacting the other layers, provided that the supporting services remain the same. Each layer consists of a set of functions designed to provide a defined series of services.

Layer 1, the physical layer (PHY), is a set of rules that specifies the electrical and physical connections between devices. This level specifies the cable connections and the electrical rules necessary to transfer data between devices. It typically takes a data stream from an Ethernet Media Access Controller (MAC) and transforms it into electrical or optical signals for transmission across a specified physical medium. PHY governs the attachment of the data terminal equipment, such as serial port of personal computers, to data communications equipment, such as modems.

Layer 2, the data link layer, denotes how a device gains access to the medium specified in the physical layer. It defines data formats, including the framing of data within transmitted messages, error control procedures, and other link control activities. Since it defines data formats, including procedures to correct transmission errors, this layer becomes responsible for reliable delivery of information.

Layer 3, the network layer, is responsible for arranging a logical connection between the source and the destination nodes on the network. This includes the selection and management of a route for the flow of information between source and destination, based on the available data paths in the networks.

Layer 4, the transport layer, assures that the transfer of information occurs correctly after a route has been established through the network by the network level protocol.

Layer 5, the session layer provides a set of rules for establishing and terminating data stream between nodes in a network. These include establishing and terminating node connections, message flow control, dialogue control, and end-to-end data control.

Layer 6, the presentation layer, addresses the data transformation, formatting, and syntax. One of its primary functions of this layer is the conversion of transmitted data into a display format appropriate for a receiving device.

Layer 7, the application layer, acts as a window through which the application gains access to all the services provided by the model. This layer typically performs such functions as file transfers, resource sharing and database access.

As the data flows within a network, each layer appends appropriate heading information to frames of information flowing within the network, while removing the heading information added by the proceeding layer.

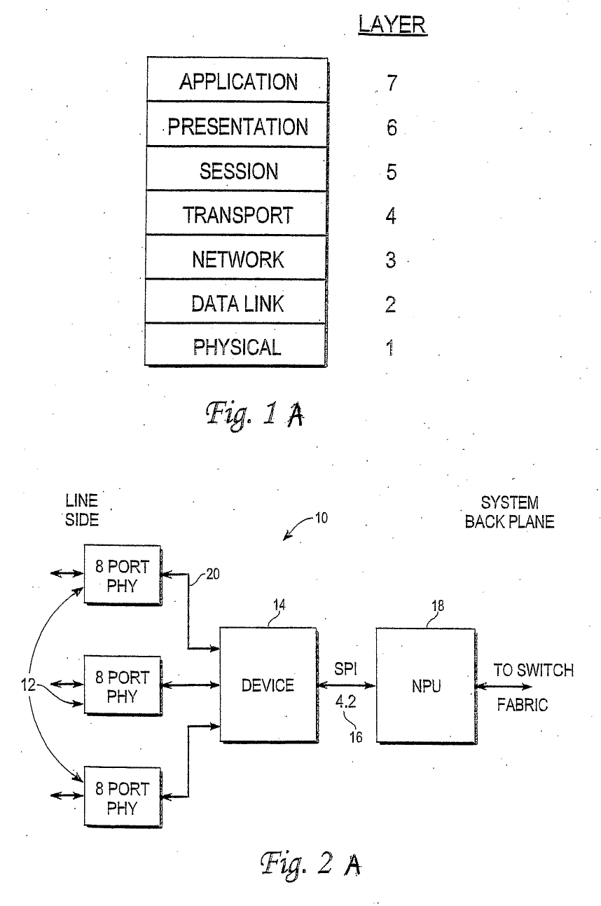

Shown in FIG. 2A is the over-all basic block diagram 10 of the interaction of the typical embodiment of the device of this invention 14 and other communications components. The data enters form the line side via a PHY 12 device (ingress) and may flow bi-directionally. In this case PHY 12 is an 8 Port device capable of operating at 10 Mega bits per second (Mbps), 100 Mbps or 1 Giga bit per second (Gbps) for each port, resulting in a total of 24 Gbps for 24 ports. The information from the PHY 12 is transmitted to the device 14 via interface 20, typically Reduced Medium-independent Interface (RMII) or Reduced Gigabit Medium-Independent Interface (RGMII). The device 14 aggregates the information from all 24 ports and transmits it to Network Processor Unit (NPU) 18 via System Packet Interface Level 4 Phase 2 (SPI 4.2) or a device of similar capability. Depending on the operating speed of SPI 4.2 or a device of similar capability and a particular RGMII mode used, e.g. 1 Gigabits/sec, the device 14 may be oversubscribed by a ratio of up to 8:1 on the line side. The data is then directed from NPU 18 to suitable switch fabric on the system back-plane.

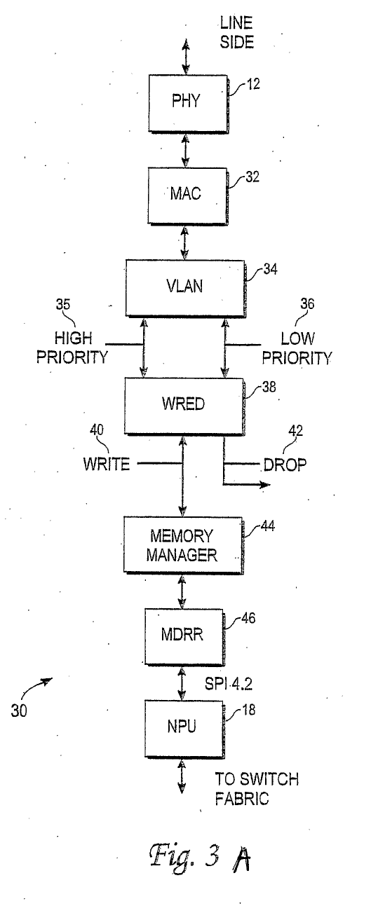

Shown in FIG. 3A is the general process flow chart applicable to each port for the data being transmitted between the PHY 12 and the switch fabric. The data enters the device 14 via a generally available Media Access Control Device (MAC) 32. The MAC 32 may be integrated with the device 14 or it may be a separate unit. In general terms MAC 32 or a similar device is employed to control the access when there is a possibility that two or more devices may want to use a common communication channel. In this embodiment device 14 employs up to 24 MACs 32.

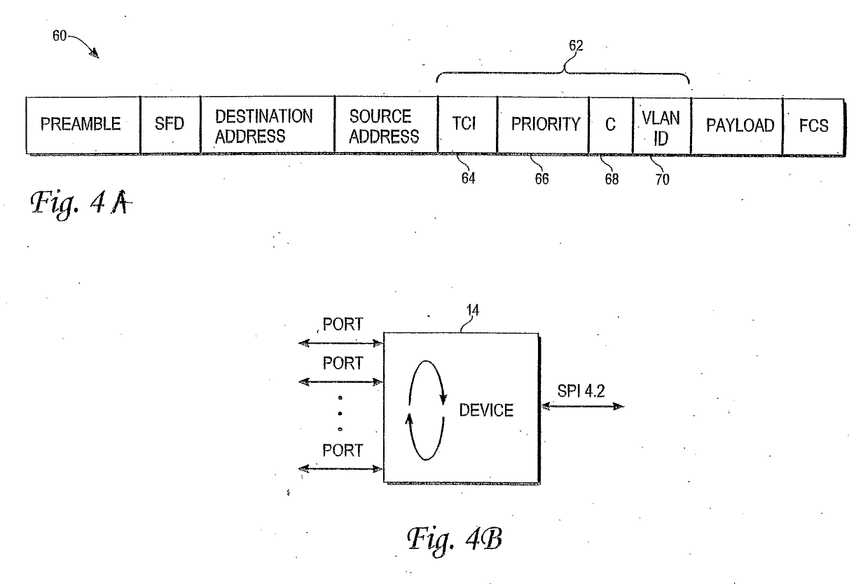

The Ethernet data stream is typically transmitted to the ingress side of device 14 in Ethernet frame format 60 with a virtual Local Area Network (vLAN) tag 62 shown in FIG. 4A. The Ethernet frame 60 conforms with IEEE 802.1Q frame format. The primary purpose of the vLAN tag 62 is to determine the priority of the incoming data traffic based on Class of Service (CoS) and classify it accordingly. The components of the VLAN tag 62 are: Tag Control Identifier (TCI) 64, Priority filed 66 (typically 3 bits of data per IEEE 802.1p standard), Canonical Format Identifier 68 and VLAN identity information 70 (typically 12 bits of data). Generally, the vLAN 62 makes it appear that a set of stations and applications are connected to a single physical LAN when in fact they are actually not. The receiving station can determine the type of the frame and correctly interpret the data carried in the frame. One with skill in the art would be able to program the type of routine needed to retrieve this information. To properly identify the type of the frame received, the value of the bits following the source address is examined. If the value is greater than 1500, an Ethernet frame is indicated. If the value is 8100, then the frame is IEEE 802.1Q tagged frame and the software would look further into the tag to determine vLAN identification and other information.

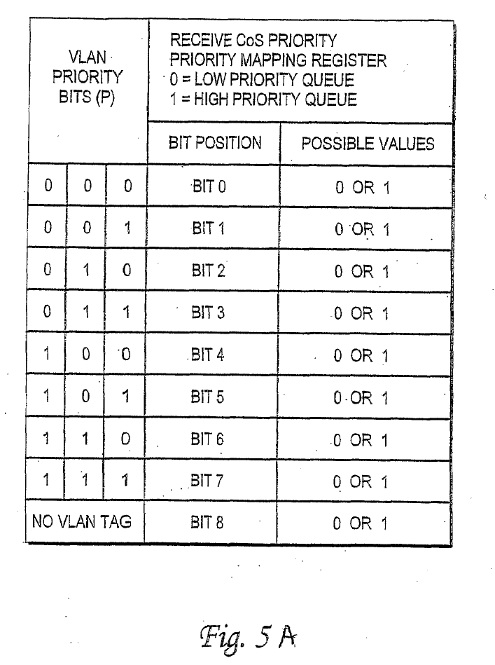

All ingress ports are scanned in round robin fashion resulting in an equitable process for selecting ports for enqueueing, i.e. for entering the device 14. This is shown in FIG. 4B. Multiple priority queues are associated with each port. Some queues are used for high priority traffic and some for low priority traffic. The over-subscription logic of device 14 obtains priority designation from the vLAN priority field 66 of the vLAN tag 62. The 3-bit vLAN priority field 66 indexes into a user programmable table that provides the lookup needed to determine the priority level. Typically, the upper four of the eight priority levels are mapped into a high priority queue and the lower four priority levels are mapped into low priority queue. If there is no VLAN 62 tag, all levels default to a single queue. FIG. 5A shows vLAN priority field 66 mapping table and the Class of Service (CoS) priority mapping register.

The device 14 also employs an IEEE 802.3-2000 compliant flow control mechanism. Each RGMII port with its MAC will perform independent flow control processing. The basic mechanism uses the PAUSE frames per the 802.3x specification. Each of the high and low priority queues associated with each port is programmed with a desired threshold value. When this value is exceeded, a PAUSE frame is generated and sent to a remote upstream node. The device 14 provides two different options for the PAUSE frame. In the first option, a 16-bit programmable timer value is sent in the PAUSE frame, this bit being used by the receiver as a pause quantum. No further PAUSE frames are sent. When the quantum expires, the transmission begins again. In the second option, the MAC sends a PAUSE frame when the threshold is exceeded and another PAUSE frame with a zero pause quanta when the buffers go below threshold signifying that the port is ready to receive data again.

An additional feature of the device of this invention found in the Layer 2 (Data Link Layer) is Weighted Random Early Detection (WRED) 38 (see FIG. 3) scheme, presently available in the art. Here, WRED is employed to limit the incoming data rate to avoid congestion by dropping some of the data packets per a predetermined criteria. In this scheme, frames are dropped with some probability if certain threshold is exceeded. Anticipating congestion and dropping frames early in this manner, congestion due to bursty traffic can be avoided.

Generally, Random Early Detection (RED) aims to control the average queue size by indicating to the end hosts when they should temporarily slow down transmission of packets. RED takes advantage of the congestion control mechanism of Transmission Control Protocol (TCP). By randomly dropping packets prior to periods of high congestion, RED communicates to the packet source to decrease its transmission rate. Assuming the packet source is using TCP, it will decrease its transmission rate until all the packets reach their destination, indicating that the congestion is cleared. Additionally, TCP not only pauses, but it also restarts quickly and adapts its transmission rate to the rate that the network can support. RED distributes losses in time and maintains normally low queue depth while absorbing spikes. When enabled on an interface, RED begins dropping packets when congestion occurs at a pre-selected rate.

### Packet Drop Probability

The packet drop probability is based on the minimum threshold, maximum threshold, and mark probability denominator. When the average queue depth is above the minimum threshold, RED starts dropping packets. The rate of packet drop increases linearly as the average queue size increases until the average queue size reaches the maximum threshold. The mark probability denominator is the fraction of packets dropped when the average queue depth is at the maximum threshold. For example, if the denominator is 256, one out of every 256 packets is dropped when the average queue is at the maximum threshold. When the average queue size is above the maximum threshold, all packets are dropped.

The minimum threshold value should be set high enough to maximize the link utilization. If the minimum threshold is too low, packets may be dropped unnecessarily, and the transmission link will not be fully used. If the difference between the maximum and minimum thresholds is too small, many packets may be dropped at once.

WRED 38 combines the capabilities of the RED algorithm with the Internet Protocol (IP) precedence feature to provide for preferential traffic handling of higher priority packets. WRED 38 can selectively discard lower priority traffic when the interface begins to get congested and provide differentiated performance characteristics for different classes of service. WRED 38 can also be configured to ignore IP precedence when making drop decisions so that non-weighted RED behavior is achieved.

WRED 38 differs from other congestion avoidance techniques such as queueing strategies because it attempts to anticipate and avoid congestion rather than control congestion once it occurs. WRED 38 makes early detection of congestion possible and provides for multiple classes of traffic.

By dropping packets prior to periods of high congestion, WRED 38 communicates to the packet source to decrease its transmission rate. If the packet source is using TCP, it will decrease its transmission rate until all the packets reach their destination, which indicates that the congestion is cleared.

### Average Queue Size

The average queue size is based on the previous average and the current size of the queue. The formula is:

average=(old average*(1−2⁻ⁿ))+(current queue size*2⁻ⁿ)

where n is the exponential weight factor, a user-configurable value. For high values of n, the previous average becomes more important. A large factor smooths out the peaks and lows in queue length. The average queue size is unlikely to change very quickly, avoiding drastic swings in size. The WRED 38 process will be slow to start dropping packets, but it may continue dropping packets for a time after the actual queue size has fallen below the minimum threshold (Kbytes). The slow-moving average will accommodate temporary bursts in traffic. For low values of n, the average queue size closely tracks the current queue size. The resulting average may fluctuate with changes in the traffic levels. In this case, the WRED 38 process responds quickly to long queues. Once the queue falls below the minimum threshold, the process will stop dropping packets. If the value of n gets too low, WRED 38 will overreact to temporary traffic bursts and drop traffic unnecessarily. If the average is less than the minimum queue threshold, the arriving packet is queued. If the average is between the minimum queue threshold and the maximum queue threshold, the packet is either dropped or queued, depending on the packet drop probability. If the average queue size is greater than the maximum queue threshold, the packet is automatically dropped.

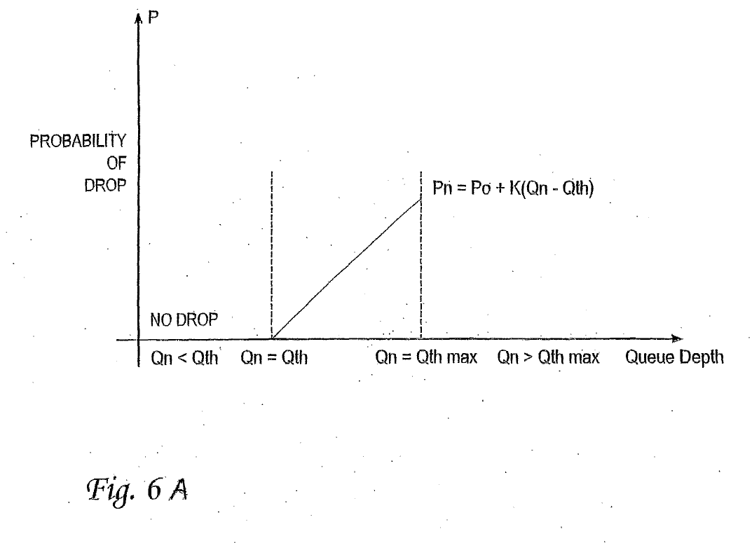

Specifically, WRED 38 provides up to four programmable thresholds (watermarks) associated with each of the two queues. Corresponding to four thresholds, four programmable probability levels are provided creating four threshold-probability pairs. This relationship is shown in FIG. 6A, where Probability of Drop is given by the following expression:

Pₙ=P₀+K(Q_{wn}−Qₜₕ)

Pₙ=the new calculated probability
P₀=user programmable initial probability
Qₜₕ=the initial threshold level of the queue
Q_{wn}=the n level watermark
K=constant

The threshold is the value on queue level (queue depth) and the corresponding probability is the probability of dropping a frame if the corresponding threshold is exceeded. It is also possible to set thresholds on some ports to guarantee no frame drops. This option is possible for only a subset of ports operating in the 1 Gbps mode.

The value of constant K determines how big the probability of drop is for a given queue filling over the threshold Qₜₕ. One skilled in the art will be able to determine proper level of K for the specific application. The device 14 supports four programmable watermarks per queue and based on each level, Pₙ, the probability for drop is calculated for the next sequence. The frames which are not dropped are written into the device 14 memory, such memory being either internal or external to the device 14. The threshold for low and high priority queues are programmed in the device 14 registers. Here, the device 14 utilizes CfgRegRxPauseWredLpThr and Cfg RegRxPauseWredHpThr registers. Associated probabilities are programmed into registers: CfgRegRxWredLpProb and CfgRegRxPauseWredHpThr. A person skilled in the art will be able to properly define such registers.

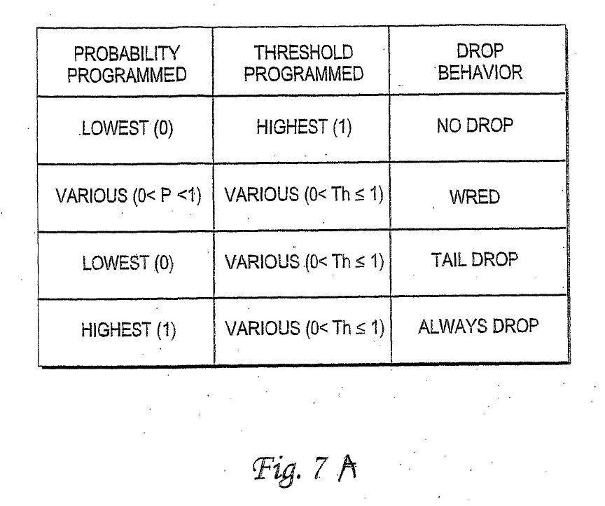

FIG. 7 shows combination of probability and threshold levels used and the corresponding frame drop behavior.

### Enqueueing Operation

Generally, frames enter from the RGMII interface into the MAC 32 receive side and are subjected to vLAN and WRED tests described above before writing into the receive memory located in the receive memory manager 44. Memory manager 44 is organized as a pool of preferably 1 Kbyte buffers (or blocks) for a minimum of 480 blocks in case of a 24 port device 14. The 1 Kbyte buffer size enables easy memory allocation from ports that have small amount or no data arriving to them to other ports that are more occupied and need the memory. The buffers can be further classified into an allocation list and the free list. Each port has two allocation lists, one is high priority queue and the other a low priority queue. The high priority queue can occupy between 1 and 32 blocks unless there is no priority mechanism and all packets fall into one queue. The low priority queue can occupy between 1 and 48 blocks. The size of the low priority queue is larger than the high priority queue because the high priority queue is serviced more frequently. The buffers are reserved as soon as the data transmission starts, i.e., as soon as vLAN tag has been read and the data is classified as high or low priority queue. The unoccupied buffers are kept in a free list and signify the amount of memory remaining after the total of 480 Kbytes have been decremented by the allocation list.

The receive memory operates at a frequency of 140 MHz making a total of 36 Gbps of bandwidth for writing and reading the data. The memory may be a dual ported RAM or a device with similar capabilities. This memory is sufficient to handle the case of all 24 ports running at 1 Gbps and SPI 4.2 running at full speed.

In one embodiment of the device, the data are written into the memory manager by Receive Write Memory Manager (RxWrMemMgr) that generally functions as follows:

Operates at 155 MHz system clock frequency.
Reads 32 bytes from each port in a round robin fashion.
Retrieves free buffers for the requesting ports from the free list.
Uses the priority information in the start of packet (SOP) inband control word to write into memory buffer.
Forms the address to write data read from the RxMacFifo (receive MAC, first in first out) into the memory by appending the pointer to memory buffer from the allocation list and the curr (current)_wrl_ptr_curr_wr_offset incremented after every write.
Increments EOP (end of packet) counter associated with each queue after writing in the last byte (Error/Valid EOP).
Uses the drop registers to decide on packet drops. When a number of buffers used per queue exceeds certain threshold, packets are dropped with fixed probability. The threshold and the probability are programmed in the four WRED registers associated with each queue. Drop is achieved by reading packets from the RxMacFifo but not writing them into the memory.

RxWrMemMgr employes the following basic data structure:

A 480 entry buffer list pointing to the start of each of the 480 Kbyte buffers (rx_free_list).
High (up to 32 entries) and low (up to 48 entries) allocation lists per port (rx_port_qh and rx_port_ql).
A current write offset into the current active buffer for each que (rx_curr_wr_offset).
A current read offset into the current active buffer for each queue (rx_curr_rd_offset).
A write pointer pointing to written buffers for the entry allocation list (rx_port_buffers_wrt_ptr).
A read pointer pointing to read buffers for the entry list (rx_port_buffers_rd_ptr).
A set of four Drop registers per port for setting thresholds for the WRED-like function. The registers contain threshold for the number of buffers used by the port and the probability associated with dropping a packet for that particular threshold.
An EOP (end of packet) counter associated with each queue that is incremented whenever a complete packet is written into the memory. Functions:
A pop function that looks at the address of free buffer(s), free_list, sends that information to the requesting port and returns a pointer to a free buffer to the requesting port.

function pop 0;
{
return (ptr_to_free_buff);
}

A push function that returns the used buffer to the free _list from logic:

function push (ptr_to_used_buffer;)
{
return (status);
}

A read scheduler (arbiter-arb) that returns next port to be read from:

function next_port (input req [(0:23])
{
return (next_port_to_read);
}

### Dequeueing Operation

The Receive Read Memory Manager is responsible for de-queueing data from the 48 (24 high priority and 24 low priority) queues and it operates at 155 MHz system clock frequency. Ports are serviced in a round robin fashion, however, within a port, high and low priority queues are serviced using commercially available MDRR 46 (Modified Deficit Round Robin) based approach.

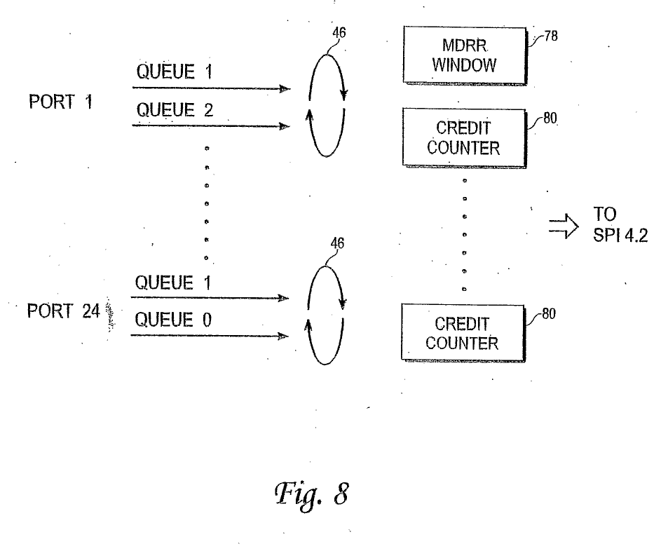

The MDRR 46 approach provides fairness among the high and low priority queues and avoids starvation of the low priority queues. Complete Ethernet frames are read out from each queue alternatively until the associated credit register reaches zero or goes negative. The MDRR 46 approach assigns queue 1 of the group as low latency, high priority (LLHP) queue for special traffic such as voice. This is the highest priority Layer 2 CoS queue. LLHP queue is always serviced first and then queue 0 serviced. A configurable credit window 78 and credit counter 80 shown in FIG. 8 are added for each high and low priority queues. The credit window 78 sets the maximum bound for dequeueing for the port. The credit counter 80 represents the number of 16-byte transfers available for the queue for the current round. The credit counter 80 is checked at the beginning of the service and if the credit count is positive, the queue is serviced. If the credit count is zero, but the queue contains at least a maximum burst 1 or maximum burst 2 bytes the queue will be serviced. Once a queue is serviced a fixed amount of programmable credits are added to the queue. The only time a queue will not be serviced is when there is no data in the queue.

The dequeued data are transmitted via SPI 4.2 to NPU 18 or a device of similar capability.

### Transmit Write Memory Manager (TxWrMemMgr)

The transmit memory is organized as a pool of 240 1 K Byte buffers. The TxWrMemMgr operates at 155 MHz and reads 32 bytes from each SPI 4.2 port in a round robin fashion, retrieves free buffers for requesting ports from the free list, forms the address to write data from the RxMacFifo into the memory by appending the pointer to memory buffer from the allocation list and the curr_wr_ptr and increments it after every write and increments EOP counter (eop_counter) associated with each port after writing in the last byte (Error/Valid EOP). The memory operates at 140 MHz and has a total bandwidth of 35 Gbits for reading and writing the data.

The TxWrMemMgr employees the following basic data structure:

A 240 entry free list buffer pointing to the start of each of the 240 1 Kbyte buffers (tx_free_list).
One 32 entry allocation list per port (tx_port_ql).
A current write offset for pointing into the current write location in the active buffer for each queue (tx_curr_wr_offset).
A current read offset for pointing into the current read location in the active buffer for each queue (tx_curr_rd_offset).
A Write pointer pointing to written buffers for the 32 entry allocation list (tx_port_buffers_wrt_ptr).
A Read pointer pointing to the read buffers for the 32 entry list (tx_port_buffers_rd_ptr).
An EOP counter (eop_counter) associated with each queue that is incremented whenever a complete packet is written into the memory.

### Functions:

A pop function that pops a buffer form the free_list and returns a pointer to a free buffer to a requesting port.

function pop 0;
{
return (ptr_to_free_buff);
}

A push function that returns used buffers to the free _list from logic.

Function push (ptr_to_used_buffer);
{
return (status):
}

In this application, the terms data, frame, packet are used interchangeably This device addresses the need to increase the oversubscription of customer ports beyond what is possible in a single device, making lower per-port system costs feasible.

The purpose of the invention is to adjust the QoS levels of the incoming traffic before the traffic is placed into the priority queues of the Active Queue Management (AQM) block of the device. By providing many different mapping tables during the classification stage of the ingress traffic processing, the invention permits the traffic from many different users to be coalesced into the appropriate QoS queue in the device, using different mapping schemes. Because this occurs before the AQM block, lower priority traffic may be dropped during periods of congestion, while higher priority traffic is preserved because it will have been placed in a queue that is serviced before the lower priority traffic. Because the system-interface can accommodate only a certain level of traffic, the traffic must be properly sorted before it reaches the data processor. Since the QoS coalescence takes place in hardware at the front-end of the device, a lower-cost data processor can be used to service the data stream. An essential part of the invention is the ability to use several disparate mechanisms for classifying the ingress traffic streams. The invention is able to classify and coalesce data based on VLAN tags, Layer 2 destination address, MPLS tags, ethertype, Link layer Control/Sub Network Access Control (LLC/SNAP) protocol, Layer 3 protocol, and/or DSCP codepoints. These different mechanisms are required because the evolution of data transport has been rapid and decentralized, resulting in the intermingling of Ethernet frames that make use of different mapping schemes. See FIG. 1.

The invention consists of two essential parts: the Classification Engine and the Class of Service (CoS) Coalescer. The Classification Engine uses a number of different aspects of the data traffic, each of which may be programmed and modified to suit the particular needs of the customers being served. The Classification Engine uses either MPLS label or VLAN ID number to determine how the ingress QoS should be adjusted to form a common CoS schema. See the Attachment A sections 2.5 through 6 for a more complete Classification Engine description.

The invention employees a set of multiple mapping tables, each of which can be programmed by the user to match the particular circumstance appropriate for the traffic being mapped. The selection of which mapping table to apply to each ingress frame is made by the Classification Engine. The mapping tables are designed to map the ingress traffic into up to eight different CoS queues. Each QoS mapping table operates independently.

The mapping tables are arranged as shown in Table 1 or Table 4. The Classification Engine is used to find the ingress QoS field. This is then used as an index to find the CoS level. As shown in the Table, the QoS to CoS mapping defaults to industry-standard mapping.

TABLE 1
QoS-to-CoS Mapping Table with Default Values

| Ingress | | |
|---|---|---|
| QoS | CoS | Comments |
| 0 (no QoS) | 2 | Best effort |
| 1 | 0 Background | (lowest) |
| 2 | 1 Spare | |
| 3 | 3 Excellent | |
| 4 | 4 Controlled | |
| 5 | 5 Video | |
| 6 | 6 Voice | |
| 7 | 7 | Network management (highest) |

However, the user can reprogram the Table, as shown in Table 2. Here an example is shown of how the ingress traffic can be demoted to a lower CoS level. This mapping could be used to handle customer traffic that is being serviced under an SLA that provides lower quality service, probable at a reduced rate.

TABLE 2
QoS-to-CoS Mapping Promoting CoS

| Ingress | |
|---|---|
| QoS | CoS |
| 0 | 3 |
| 1 | 1 |
| 2 | 2 |
| 3 | 4 |
| 4 | 5 |
| 5 | 6 |
| 6 | 7 |
| 7 | 7 |

Similarly, Table 3 shows how the table can be used to promote ingress table. The invention is set up such that the mapping table assigned to a particular's customer data can be changed on the fly. This will permit, for example, the customer to switch to a better mapping during office hours, or perhaps during a critical time period, such as a Payroll download to Corporate.

TABLE 3
QoS-to-CoS Mapping Demoting CoS

| Ingress | |
|---|---|
| QoS | CoS |
| 0 | 1 |
| 1 | 0 |
| 2 | 0 |
| 3 | 2 |
| 4 | 3 |
| 5 | 4 |
| 6 | 5 |
| 7 | 6 |

The invention also permits a non-QoS field of the Ethernet VLAN tag to be used to further expand how traffic CoS can be assigned, as shown in Table 4. Here the Canonical Format Indicator (CFI) field of the Ethernet VLAN tag is used to provide further subdivision of the ingress QoS levels to CoS levels.

TABLE 4
QoS-to-CoS Mapping Table Using CFI Bit with Default Values

| CFI | Ingress QoS | CoS | Comments |
|---|---|---|---|
| 0 | 0 | 2 | Best effort |
| 0 | 1 | 0 | (lowest) |
| 0 | 2 | 1 | |
| 0 | 3 | 3 | |
| 0 | 4 | 4 | |
| 0 | 5 | 5 | |
| 0 | 6 | 6 | |
| 0 | 7 | 7 | Network management (highest) |
| 1 | 0 | 2 | Best effort |
| 1 | 1 | 0 | (lowest) |
| 1 | 2 | 1 | |
| 1 | 3 | 3 | |
| 1 | 4 | 4 | |
| 1 | 5 | 5 | |
| 1 | 6 | 6 | |
| 1 | 7 | 7 | Network management (highest) |

What is claimed is:

1. A method for classifying data traffic comprising:
providing traffic to an ingress port;
determining the priority level assigned to the traffic;
classifying the traffic per the customer's level of service.
